(19) United States
(12) Patent Application Publication
(10) Pub. No.: US 2007/0086297 A1
(43) Pub. Date: Apr. 19, 2007

(54) Disk discrimination method and apparatus of optical disk system

(75) Inventors: Nam-Taek Hyung, Suwon-si (KR); Jae-Heon Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/580,122

(22) Filed: Oct. 13, 2006

(30) Foreign Application Priority Data
Oct. 13, 2005 (KR) 10-2005-0096497

(51) Int. Cl. G11B 7/00

(52) U.S. Cl. 369/53.23

(57) ABSTRACT

A disk discrimination method and apparatus of an optical disk system may be provided. The disk discrimination method of an optical disk system may include measuring a frequency of a tracking error signal during tracking control of a disk to be discriminated; and discriminating a type of the disk according to the frequency of the tracking error signal.

### PRIORITY STATEMENT

This U.S. non-provisional application claims the benefit of Korean Patent Application No. 10-2005-0096497, filed on Oct. 13, 2005, in the Korean Intellectual Property Office (KIPO), the entire contents of which is incorporated herein by reference.

### BACKGROUND

1. Field

Example, non-limiting embodiments relate to a disk discrimination method and apparatus of an optical disk system, for example, a disk discrimination method and apparatus for discriminating a type of disk using a frequency of a tracking error signal.

2. Description of the Related Art

A conventional disk discrimination method may discriminate a type of optical disk according to the amplitude of a focusing control signal or a tracking error signal. For example, the conventional disk discrimination method may measure the amplitude of the focusing control signal while a focusing control operation may be performed in an optical disk system. Alternatively, the conventional disk discrimination method may measure the amplitude of the tracking error signal while a tracking control operation may be performed in the optical disk system. A type of optical disk may be discriminated according to the measured amplitude of the focusing control signal or the tracking error signal.

However, the amplitude of the focusing control signal or the tracking error signal may be different in optical disks of the same type due to various causes that may occur in a disk manufacturing process.

Thus, the conventional disk discrimination method may have a possibility of wrongly discriminating a type of optical disk.

### SUMMARY

Example, non-limiting embodiments may provide a disk discrimination method of an optical disk system for discriminating a type of disk using a frequency of a tracking error signal.

Example, non-limiting embodiments may provide a disk discrimination apparatus of an optical disk system for discriminating a type of disk using a frequency of a tracking error signal.

In an example, non-limiting embodiment, a disk discrimination method of an optical disk system may include measuring a frequency of a tracking error signal during tracking control of a disk to be discriminated; and discriminating a type of the disk according to the frequency of the tracking error signal.

According to an example, non-limiting embodiment, the frequency of the tracking error signal may be measured at the time of complete focus during focusing control of the disk.

According to an example, non-limiting embodiment, the type of the disk may be discriminated by comparing the frequency of the tracking error signal to a predetermined or given reference value. The predetermined or given reference value may be determined according to a speed of an optical pickup of the optical disk system moving across the disk.

According to an example, non-limiting embodiment, the disk may be discriminated as DVD-RAM if the frequency of the tracking error signal is lower than the predetermined or given reference value.

According to an example, non-limiting embodiment, the disk may be discriminated as other than DVD-RAM if the frequency of the tracking error signal is higher than the predetermined or given reference value

According to an example, non-limiting embodiment, the method may further include filtering the tracking error signal, wherein, measuring the frequency of the filtered tracking error signal is performed by measuring the frequency of the filtered tracking error signal.

According to an example, non-limiting embodiment, the method may further include binarizing the tracking error signal, wherein measuring the frequency of the tracking error signal is performed by measuring the frequency of the binarized tracking error signal. In the binarization of the tracking error signal, the tracking error signal may be binarized using a hysteresis characteristic.

In an example, non-limiting embodiment, a disk discrimination apparatus of an optical disk system may include a frequency measurement unit measuring a frequency of a tracking error signal during tracking control of a disk to be discriminated; and a disk type discriminator discriminating a type of the disk according to the frequency of the tracking error signal.

According to an example, non-limiting embodiment, the frequency measurement unit may measure the frequency of the tracking error signal at the time of complete focus during tracking control or focusing control of the disk.

According to an example, non-limiting embodiment, the disk type discriminator may discriminate the type of the disk by comparing the frequency of the tracking error signal to a predetermined or given reference value. The predetermined or given reference value may be determined according to a speed of an optical pickup of the optical disk system moving across the disk.

According to an example, non-limiting embodiment, the disk type discriminator may discriminates the disk as DVD-RAM if the frequency of the tracking error signal is lower than the predetermined or given reference value.

According to an example, non-limiting embodiment, the disk type discriminator may discriminate the disk as other than DVD-RAM if the frequency of the tracking error signal is higher than the predetermined or given reference value.

According to an example, non-limiting embodiment, the apparatus may further include a filtering unit that may filter the tracking error signal, wherein the frequency measurement unit may measure a frequency of the filtered tracking error signal.

According to an example, non-limiting embodiment, the apparatus may further include a binarization unit that may binarize the tracking error signal, wherein the frequency measurement unit may measure a frequency of the binarized tracking error signal. The binarization unit may binarize the tracking error signal using a hysteresis characteristic.

According to an example, non-limiting embodiment, the apparatus may further include a tracking error signal output unit that may measure the tracking error signal during the tracking control of the disk.

### BRIEF DESCRIPTION OF THE DRAWINGS

Example, non-limiting embodiments will be described with reference to the attached drawings.

FIG. 1 is a diagram of an operation of an optical pickup in an optical disk system;

FIG. 2 is a flowchart of a disk discrimination method of an optical disk system according to an example, non-limiting embodiment.

FIGS. 3A and 3B are graphs of variations of a sum signal of light receiving elements and a tracking error signal in an optical disk system according to an example, non-limiting embodiment.

FIG. 4 is a block diagram of a disk discrimination apparatus of an optical disk system according to an example, non-limiting embodiment.

### DETAILED DESCRIPTION OF EXAMPLE, NON-LIMITING EMBODIMENTS

Various example embodiments are described more fully hereinafter with reference to the accompanying drawings. Example embodiments may, however, be embodied in many different forms and should not be construed as limited to example embodiments set forth herein. Rather, these example embodiments are provided so that this disclosure will be thorough and complete and will fully convey the scope of example embodiments to those skilled in the art. In the drawings, the sizes and relative sizes of layers and regions may be exaggerated for clarity.

Accordingly, while example embodiments are capable of various modifications and alternative forms, it should be understood, however, that there is no intent to limit example embodiments of the invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

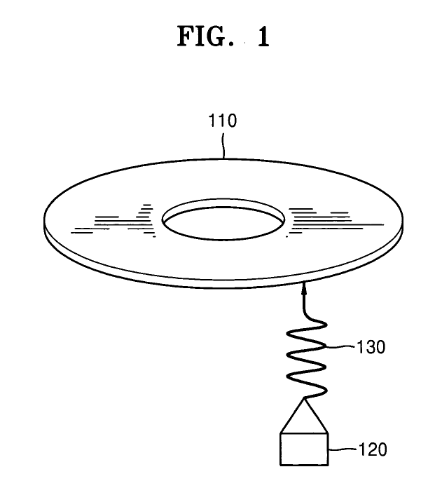

FIG. 1 is a diagram of an operation of an optical pickup 120 in an optical disk system.

Referring to FIG. 1, an optical disk system may perform focusing control or tracking control by moving an optical pickup 120. For example, the optical disk system may perform the focusing control or the tracking control by moving the optical pickup 120 up, down, left, and right relative to a surface of a disk 110. Reference numeral 130 denotes an illustration of a trajectory of a motion of the optical pickup 120.

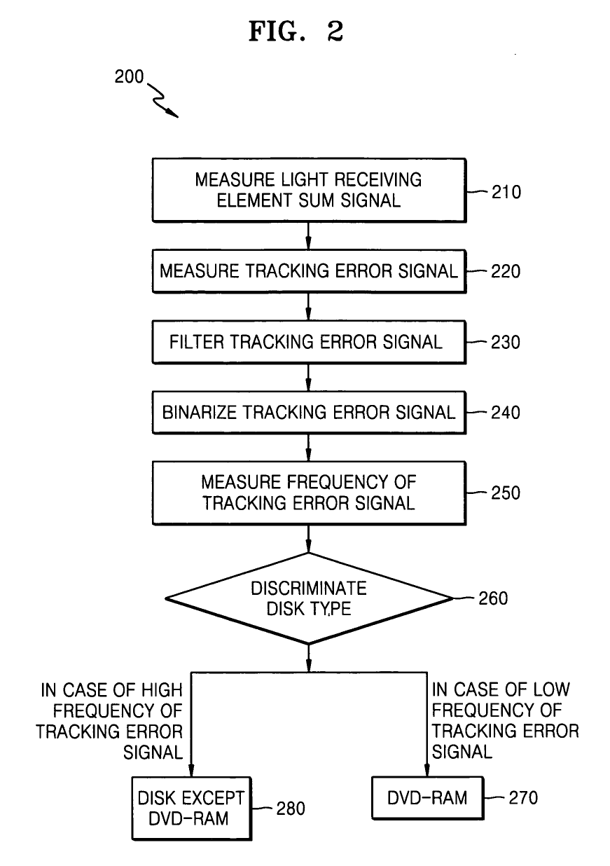

FIG. 2 is a flowchart of a disk discrimination method 200 of an optical disk system according to an example, non-limiting embodiment.

Referring to FIG. 2, a disk discrimination method 200 of an optical disk system may include a measure frequency of tracking error signal operation 250; and a discriminate disk type operation 260.

In the measure frequency of tracking error signal operation 250, a frequency of a tracking error signal may be measured during tracking control of a disk to be discriminated. In the discriminate disk type operation 260, a type of disk may be discriminated according to the frequency of the tracking error signal.

In the measure frequency of tracking error signal operation 250, a frequency of a tracking error signal may be measured at the time of complete focus during focusing control of a disk to be discriminated. For example, in the measure frequency of tracking error signal operation 250, a tracking error signal may be measured at the time of complete focus during a motion of the optical pickup 120 in the focusing control. A frequency of the measured tracking error signal may be measured. The time of complete focus may be the time when the amplitude of a sum signal of light receiving elements of the optical disk system may be greater than a predetermined or given value.

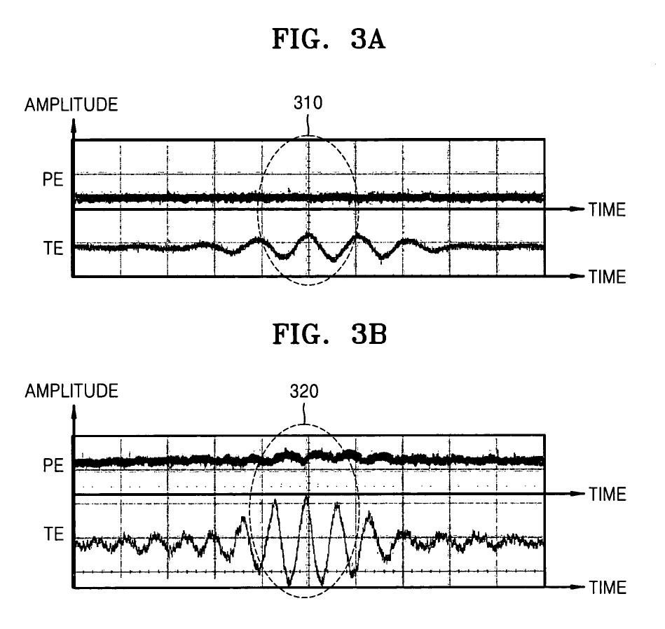

FIGS. 3A and 3B are graphs of variations of a sum signal of light receiving elements and a tracking error signal in an optical disk system according to an example, non-limiting embodiment. FIG. 3A is a sum signal PE of the light receiving elements and a tracking error signal TE, which may be measured from a DVD-RAM. FIG. 3B is a sum signal PE of the light receiving elements and a tracking error signal TE, which may be measured from a DVD-R.

Referring to FIG. 3A, in the case of a DVD-RAM, a frequency of a tracking error signal TE may measured in an area 310 in which a sum signal PE of the light receiving elements may be greater, e.g., an area 310 of complete focus. Referring to FIG. 3B, in the case of a DVD-R, a frequency of a tracking error signal TE may be measured in an area 320 in which a sum signal PE of the light receiving elements is greater, e.g., an area 320 of complete focus.

Referring back to FIG. 2, in the discriminate disk type operation 260, a type of the disk may be discriminated by comparing the frequency of the tracking error signal measured in the measure frequency of tracking error signal operation 250 to a predetermined or given reference value.

In an example, non-limiting embodiment, the tracking control or the focusing control may be performed in advance for various types of disks. Frequencies of tracking error signals of the various types of disks may be measured at the time of complete focus. By doing this, reference values of the various types of disks may be set. In the discriminate disk type operation 260, a type of a disk to be discriminated may be discriminated by comparing a frequency of a tracking error signal measured from the disk to be discriminated to the pre-set reference values of the various types of disks. For example, in the discriminate disk type operation 260, if the frequency of the tracking error signal is lower than a specific reference value, the disk to be discriminated may be discriminated as DVD-RAM in a DVD-RAM operation 270. If the frequency of the tracking error signal is higher than the specific reference value, the disk to be discriminated may be discriminated as a disk other than DVD-RAM in an except DVD-RAM operation 280.

The disk discrimination method 200 may further include a filter tracking error signal operation 230.

In the filter tracking error signal operation 230, noise may be cancelled by filtering a measured tracking error signal. For example, the tracking error signal may be high pass filtered to cancel an effect of low frequency noise or low pass filtered to cancel an effect of high frequency noise. In the discriminate disk type operation 260, a type of disk may be discriminated according to a frequency of the filtered tracking error signal.

The disk discrimination method 200 may further include a binarize tracking error signal operation 240.

In the binarize tracking error signal operation 240, the measured tracking error signal may be binarized. For example, the measured tracking error signal may be binarized using a hysteresis characteristic. The hysteresis characteristic is a characteristic of the case where, if output values are determined according to input values, an output value determined according to an input value in an input value decreasing period is different from an output value determined according to the input value in an input value increasing period. In the discriminate disk type operation 260, a type of disk is discriminated according to a frequency of the binarized tracking error signal.

The disk discrimination method 200 may further include a measure light receiving element sum signal operation 210, and a measure tracking error signal operation 220. In the measure light receiving element sum signal operation 210, a light receiving element sum signal may be measured. In the measure tracking error signal operation 220, a tracking error signal may be measured.

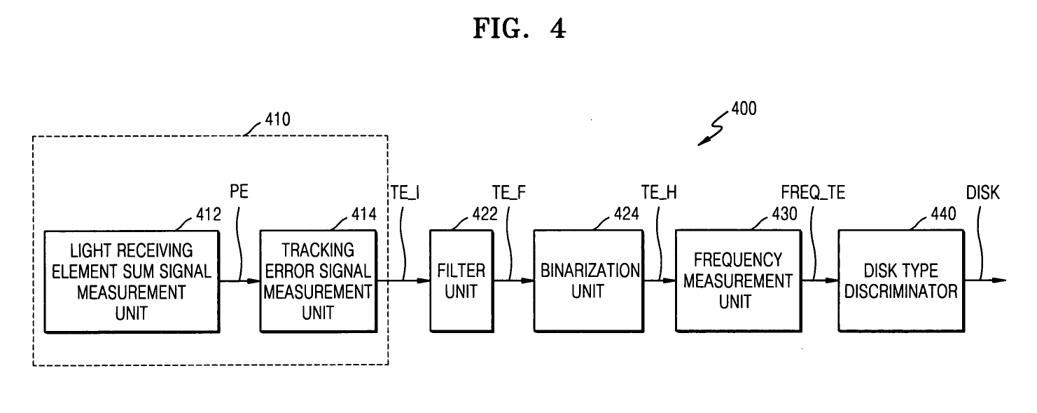

FIG. 4 is a block diagram of a disk discrimination apparatus 400 of an optical disk system according to an example, non-limiting embodiment.

Referring to FIG. 4, a disk discrimination apparatus 400 may include a frequency measurement unit 430 and a disk type discriminator 440.

The frequency measurement unit 430 may measure a frequency FREQ_TE of a tracking error signal TE_I, TE_F, or TE_H at the time of complete focus during tracking control of a disk to be discriminated. The disk type discriminator 440 may discriminate a disk type DISK according to the frequency FREQ_TE of the tracking error signal TE_I, TE_F, or TE_H.

The disk discrimination apparatus 400 may further include a signal measurement unit 410. The signal measurement unit 410 may include a light receiving element sum signal measurement unit 412 and a tracking error signal measurement unit 414. The light receiving element sum signal measurement unit 412 may output a light receiving element sum signal PE, and the tracking error signal measurement unit 414 may output the tracking error signal TE_I.

The disk discrimination apparatus 400 may further include a filter unit 422. The filter unit 422 may filter the tracking error signal TE_I and may output the filtered tracking error signal TE_F.

The disk discrimination apparatus 400 may further include a binarization unit 424. The binarization unit 424 may binarize the filtered tracking error signal TE_F and may output the binarized tracking error signal TE_H.

The disk discrimination apparatus 400 of an optical disk system may have the same technical idea as the disk discrimination method 200 of an optical disk system and may corresponds to operations of the disk discrimination method 200 of an optical disk system according to an example, non-limiting embodiment. Thus, since the disk discrimination apparatus 400 will be understood based on the above description by those of ordinary skill in the art, a detailed description of the disk discrimination apparatus 400 of an optical disk system is omitted.

As described above, in a disk discrimination method and apparatus of an optical disk system according to example, non-limiting embodiments, discriminating a disk type using a frequency of a tracking error signal may reduce errors in a disk discrimination process.

Although example, non-limiting embodiments have been shown and described in detail herein, it should be understood by those of ordinary skill in the art that various changes in form and details may be made therein without departing from the spirit and scope of the example, non-limiting embodiments as defined by the following claims.

What is claimed is:

1. A disk discrimination method of an optical disk system, the method comprising:
measuring a frequency of a tracking error signal during tracking control of a disk to be discriminated; and
discriminating a type of the disk according to the frequency of the tracking error signal.

2. The method of claim 1, wherein the frequency of the tracking error signal is measured at a time of complete focus during tracking control or focusing control of the disk.

3. The method of claim 1, wherein the type of the disk is discriminated by comparing the frequency of the tracking error signal to a reference value.

4. The method of claim 3, wherein the reference value is determined according to a speed of an optical pickup of the optical disk system moving across the disk.

5. The method of claim 3, wherein the type of the disk is discriminated as DVD-RAM if the frequency of the tracking error signal is lower than the reference value.

6. The method of claim 3, wherein the type of the disk is discriminated as other than DVD-RAM, if the frequency of the tracking error signal is higher than the reference value.

7. The method of claim 1, further comprising filtering the tracking error signal, wherein measuring the frequency of the tracking error signal is performed by measuring a frequency of the filtered tracking error signal.

8. The method of claim 1, further comprising binarizing the tracking error signal, wherein measuring the frequency of the tracking error signal is performed by measuring a frequency of the binarized tracking error signal.

9. The method of claim 8, wherein the tracking error signal is binarized using a hysteresis characteristic.

10. A disk discrimination apparatus of an optical disk system, the apparatus comprising:
a frequency measurement unit measuring a frequency of a tracking error signal during tracking control of a disk to be discriminated; and
a disk type discriminator discriminating a type of the disk according to the frequency of the tracking error signal.

11. The apparatus of claim 10, wherein the frequency measurement unit measures the frequency of the tracking error signal at the time of complete focus during tracking control or focusing control of the disk.

12. The apparatus of claim 10, wherein the disk type discriminator discriminates the type of the disk by comparing the frequency of the tracking error signal to a reference value.

13. The apparatus of claim 12, wherein the reference value is determined according to a speed of an optical pickup of the optical disk system moving across the disk.

14. The apparatus of claim 10, wherein the disk type discriminator discriminates the disk as DVD-RAM if the frequency of the tracking error signal is lower than the reference value.

15. The apparatus of claim 10, wherein the disk type discriminator discriminates the disk as other than DVD-RAM, if the frequency of the tracking error signal is higher than the reference value.

16. The apparatus of claim 10, further comprising a filtering unit filtering the tracking error signal, wherein the frequency measurement unit measures a frequency of the filtered tracking error signal.

17. The apparatus of claim 10, further comprising a binarization unit binarizing the tracking error signal, wherein the frequency measurement unit measures a frequency of the binarized tracking error signal.

18. The apparatus of claim 17, wherein the binarization unit binarizes the tracking error signal using a hysteresis characteristic.

19. The apparatus of claim 10, further comprising a tracking error signal output unit measuring the tracking error signal during the tracking control of the disk.
